(19) United States
(12) Patent Application Publication
(10) Pub. No.: US 2008/0094238 A1
(43) Pub. Date: Apr. 24, 2008

(54) Power Controller With Audio Feedback

(76) Inventors: David Shenker, Wellington, FL (US); Michael Ostrovsky, Brooklyn, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/673,282

(22) Filed: Feb. 9, 2007

Related U.S. Application Data
(60) Provisional application No. 60/772,044, filed on Feb. 10, 2006.

(51) Int. Cl. G08B 21/00

(52) U.S. Cl. 340/657

(57) ABSTRACT

A power controller generates an audible and/or visual signal corresponding to a change in output power of the power controller in response to a user input. The change in output power is limited to a single discrete step in accordance with a discrete user input. In an embodiment, the user input device is a touch-plate, and the change in output power is limited to a single discrete step with each touch of the touch-plate.

### CROSS-REFERENCE TO RELATED APPLICATION

This application claims the benefit of priority pursuant to 35 U.S.C. § 119(e) from a U.S. Provisional Application having Application No. 60/772,044 filed Feb. 10, 2006.

### FIELD OF THE INVENTION

The present invention relates to variable power controllers suitable for use with household electrical circuits.

### BACKGROUND OF THE INVENTION

Power controllers may be used to vary the power delivered to a load, to affect the operation of an electrical device such as the speed of a fan or brightness of a lamp. Power controllers are known in the art. The controller can have an input that receives power from, for example, a standard household electrical circuit. The power controller may include an ON/OFF toggle switch to enable/disable any output power from the controller. When enabled, the controller can provide an output power that can be connected to a load, such as a fan. The speed of the fan (that is, angular velocity of the fan blades) can be proportional to the output power of the controller.

The output power may be varied between a minimum and a maximum depending on a power setting selected by a user of the controller. The power setting may be selected in various ways including changing the position of a slider, rotating a dial and touching a touch-plate. Some power controllers may be continuously variable over a range of output power; others may have discrete output power levels. For example, a power controller for a fan may have three output power levels corresponding to fan rotational speeds of slow, medium and fast. A touch-plate may be used to cycle the output power through the various discrete power levels. When the touch-plate is touched, the controller can cycle through the output power levels.

### SUMMARY OF THE INVENTION

It is desirable to include an audible and/or visual signal in the operation of a power controller, to provide feedback for a user of the power controller. In accordance with the present invention, this is done by providing a power controller that includes a signal generator (e.g. a piezoelectric buzzer and/or an LED) for generating a signal corresponding to a change in output power.

According to one aspect of the invention, a power controller includes a user input device for indicating a desired change in the output power; a control circuit for causing the change in output power in response to a user input; and the signal generator. The control circuit is configured to limit the change in output power to a single discrete step between defined power levels, in accordance with a discrete user input. In one preferred embodiment, the user input device is a touch-plate, and the change in output power is limited to a single discrete step with each touch of the touch-plate. In particular, the touch-plate may be a dual touch-plate in which one portion is for indicating a desired increase in the output power and another portion is for indicating a desired decrease in the output power.

The power controller may advantageously include a latching circuit, coupled to the control circuit, for latching an input signal to the control circuit. In one preferred embodiment, the user input device is a touch-plate and the latched input signal is in accordance with a touch of the touch-plate; the change in output power is thus limited to a single discrete step with each touch of the touch-plate.

The power controller may also include a switch, e.g. a toggle switch, coupled to a power source, for switching between an ON state and an OFF state. The control circuit may be configured to hold information regarding a most recent desired output power in accordance with switching to the OFF state, and to set the output power to the most recent desired output power in accordance with subsequently switching to the ON state. The signal generator may generate a signal in accordance with switching to the ON state.

According to another aspect of the invention, a method is provided for indicating the setting of a power controller. The method includes the steps of generating an audible signal corresponding to a change in output power of the power controller in response to a user input; and limiting the change in output power of the power controller to a single discrete step in accordance with a discrete user input. The output power may be in accordance with one of a plurality of defined power levels.

Other objects and features of the disclosure will be pointed out in the following description and claims and illustrated in the accompanying drawings, which disclose, by way of example, the principles of the disclosure, and the best mode, which is presently contemplated for carrying them out.

### BRIEF DESCRIPTION OF THE DRAWINGS

In the drawings in which similar elements are given similar reference characters:

FIG. 1 is a perspective drawing of an implementation of a power controller according to an embodiment of the invention, for use in a single-gang outlet box.

FIG. 2 illustrates steps in a method for providing audible feedback for a power controller.

FIG. 3 is a block diagram of a power controller with audible feedback, in accordance with an embodiment of the invention.

### DETAILED DESCRIPTION OF PREFERRED EMBODIMENTS

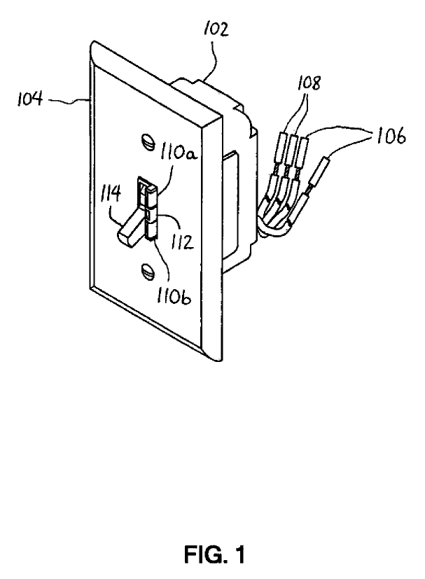

FIG. 1 illustrates an embodiment of the invention in which a power controller 102 is mounted to a single-gang switch plate 104. The power controller 102 can have one or more input wires 108 extending from the rear of the power controller to receive input power from, for example, household circuits. One or more output wires 106 extend from the rear portion of the controller 102 to provide output power to a load (not shown) such as a fan or a lamp. The power controller may include an audible device (not shown), such as a piezoelectric buzzer, to provide an audible signal to indicate the state or change of state of an output power level provided on the output wires 106. The power controller may also include an ON/OFF toggle switch 114 to enable/disable output power from the power controller. The power controller can receive an input signal to alter the output power level from a user input device such as a slider, a rotary dial or a touch-plate.

In this embodiment, the user input device is a dual touch-plate 110a, 110b. Details of a toggle switch assembly including a dual touch-plate are provided in commonly owned U.S. Pat. No. 6,420,669 to Shenker et al., the entire disclosure of which is incorporated herein by reference. The dual touch-plate 110a, 110b can be touch sensitive pads made of conductive material having a capacitance that changes in response to a user touching the touch pads. The power controller includes detection circuitry (not shown) that detects the changes and causes a signal to be generated. The dual touch plates permit output power to be raised and lowered independently; touching one of the touch-plates (e.g. plate 110a) may cause a signal to be provided to the power controller to increase the output power level to the load, while touching the other touch-plate (e.g. plate 110b) may cause a signal resulting in a decrease of the output power level to the load. The power controller may also include a visual indicator 112 such as a lamp or a light-emitting diode (LED), to provide a visual indication of the state or change of state of the output power level provided on the output wires 106.

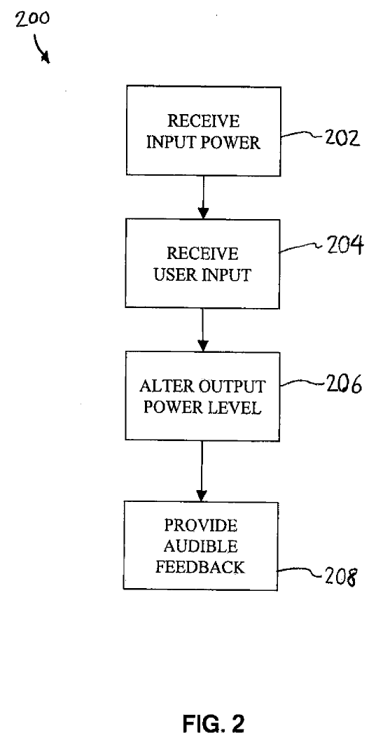

FIG. 2 is a flow diagram 200 for providing an audible feedback from a power controller. In step 202, a power controller is connected to a power source which provides power to the power controller. The power controller can provide a power level to a load. In step 204, the power controller receives a user input indicative of a desired change in the output power level of the controller. In step 206, as a consequence of the user input, the power controller changes the output power level to the load. In step 203, the power controller provides an audible signal as auditory feedback to the user indicating a change in the output power level. For example, the audible device may provide an audible signal when the toggle switch is placed in the ON position.

The audible device provides an audible signal indicative of the level of the output power. For example, in one embodiment where three discrete power levels (low, medium, high) are provided, a change to the low level of power might be indicated by a single audible signal. Two audible signals could indicate a change in the output power level to the medium level and three audible signals when the power is increased to the highest level. Similarly, a light source may be used instead of or in addition to the audible device, to indicate a change in the output power level (e.g. three light flashes when the power is increased to the highest level).

In an embodiment, an audible device and a toggle switch assembly (including an ON/OFF toggle switch and a dual touch-plate) are used in a power controller for controlling the speed of a fan. The power controller, which is coupled to a fan, adjusts the speed of the fan. When one of the dual touch-plates is touched, the fan speed increases towards a maximum value, and when the other dual touch-plate is touched the fan speed decreases towards a minimum value. The audible device provides an audible signal when the fan speed is changed.

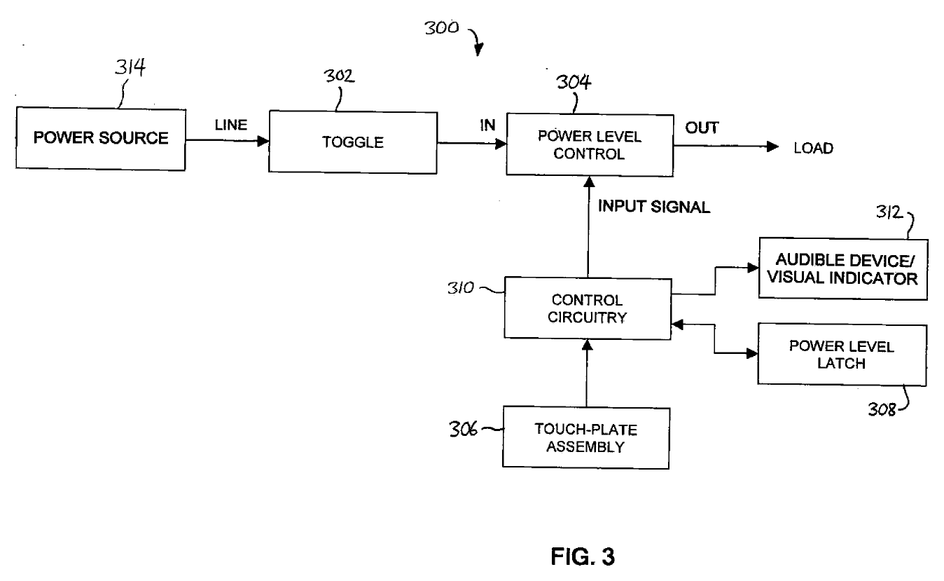

FIG. 3 is a block diagram 300 of a power controller having audible feedback, in accordance with an embodiment of the invention. Power from a line power source 314 is provided to an ON/OFF toggle switch 302. The power source 314 may be household power provided on electrical circuits. The toggle switch 302 is used to connect/disconnect the power source 314 and power level control 304 and, thus, enable/disable output power from reaching a load coupled to the power level control output. The ON state of the toggle switch 302 also can provide power to the circuitry and devices used in the power level controller. The power level control 304 serves to alter the power level output to the load to a desired level, in response to a user-provided input signal. Control 304 permits selection of any one of multiple (three or more) power levels (e.g. low-medium-high light levels for a lamp, or low-medium-high speeds for a fan).

In the embodiment shown in FIG. 3, the input signal is provided by a touch-plate assembly 306; the user touches the touch-plate to indicate a desire to change the level of the output power. As discussed above, the user input device can be a dual touch-plate: one plate to increase the output power level and one plate to decrease the output power level.

If the input signal continues to be input to control 304 for as long as the touch-plate is being touched, the user may overshoot the desired output level. For example, if the output power has three discrete levels such as low, medium and high, a prolonged touch might result in selection of the high output level instead of the desired medium level. To avoid such overshoot of the desired output power level, control circuitry 310 is configured to modify the touch-plate signal for the power level control 304. An electronic latching circuit 308 is coupled to the control circuitry 310 for latching the input signal. This ensures that only one discrete change (increase or decrease) in output power level occurs with each touch of the respective touch-plates.

In an embodiment, control circuitry 310 or latching circuit 308 includes circuitry to hold the most recent output power level desired by the user at the time when the toggle switch 302 is switched to the OFF position. This power level is then used as the power level provided by the power level control 304 when the toggle switch 302 is switched back to the ON position.

The control circuitry 310 actuates an audible device and/or visual indicator 312. The control circuitry may cause the audible device to generate sounds corresponding to different changes in the output power level. For example, in a power controller having discrete output power levels, the audible device could emit a single tone when the toggle switch is switched 302 to the ON position; two tones to indicate a medium output power level and three tones to indicate the highest output power level. Alternatively, a visual indicator could emit one, two, or three light flashes instead of the audible tones. In another example, in response to a continuous change (increase or decrease) in an analog fashion of the power level, the power controller can generate a corresponding continuous change in the frequency of the audible tone.

An additional optional benefit of the described embodiment can also be included. When a load is controlled that responds slowly to a change in power level, such as a ceiling fan for example, the power controller may give additional feedback in the form of a variable audio tone (or another form of variable feedback such as a visual indicator). The audio feedback given can be of a variable pitch in such a way that the pitch increases, or decreases as the load responds to the increasing or decreasing power. For the example of a fan, as the speed of a fan increases or decreases, the pitch of the audio feedback will increase or decrease to mimic the speed of the fan. When the fan reaches a constant speed, the pitch of the audio feedback may optionally become constant for a short period of time, such as three seconds, for example, before the audio feedback ceases. In this manner, the user would know when the load reached its selected power level.

The power controller may include a toggle switch or toggle dimmer electrical device as part of a single-gang wall plate, and be mounted (ganged) with other toggle switches and/or other toggle dimmers. In a fan speed controller, the audible device may be a piezoelectric element configured to generate an audible signal indicating a change of speed of the fan, for example, generating a defined number of beeps corresponding to a selected speed level. The audible device also may be configured to generate a signal when the electrical device is initially turned on to verify the speed setting or level. Furthermore, the present speed setting may be stored in a memory when power to the device is turned off so that, when the device is subsequently turned on, the device can be set to the previously stored setting.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

1. A power controller comprising:
an actuator;
a control circuit coupled to the actuator and responsive to the actuator to regulate an output power of the power controller; and
a signal generator coupled to the control circuit, for generating at least one audible signal in response to a change in the output power.

2. A power controller according to claim 1, wherein the control circuit causes the output power to change to one of a plurality of defied power levels.

3. A power controller according to claim 1, wherein the actuator is a touch-plate, and said change in output power is limited to a single discrete step with each touch of the touch-plate.

4. A power controller according to claim 3, wherein the touch-plate is conductive and the touch-plate is responsive to a ground leakage current through the body of a user.

5. A power controller according to claim 3, wherein the touch-plate is responsive to a change in the capacitance of the touch-plate.

6. A power controller according to claim 3, wherein the touch-plate is a dual touch-plate having a first portion for indicating a desired increase in the output power and a second portion for indicating a desired decrease in the output power.

7. A power controller according to claim 6, wherein the touch-plate is conductive and the touch-plate is responsive to a ground leakage current through the body of a user.

8. A power controller according to claim 6, wherein the touch-plate is responsive to a change in the capacitance of the touch-plate.

9. A power controller according to claim 1, wherein the signal generator includes a piezoelectric device for producing the audible signal.

10. A power controller according to claim 1, further comprising a latching circuit, coupled to said control circuit, for latching an input signal to the control circuit.

11. A power controller according to claim 10, wherein the user input device is a touch-plate and said latched input signal is in response to contact with the touch-plate, so that said change in output power is limited to a single discrete step with each touch of the touch-plate.

12. A power controller according to claim 1, further comprising a switch, coupled to a power source, for switching between an ON state and an OFF state.

13. A power controller according to claim 1, wherein said output power supplies power to a load, where said load has a response to a change in said output power, said audible signal has an audible frequency, and said audible frequency is variable such that said audible frequency is determined by said response of said load.

14. A power controller according to claim 12, wherein the control circuit is configured to hold information regarding a most recent desired output power in accordance with switching to the OFF state, and to set the output power to said most recent desired output power in accordance with subsequently switching to the ON state.

15. A power controller according to claim 12, wherein the control circuit is configured to cause the signal generator to generate a signal in accordance with switching to the ON state.

16. A power controller according to claim 12, wherein the control circuit includes a memory device for storing the information regarding the most recent desired output power.

17. A method of indicating the setting of a power controller, comprising the steps of:
receiving a user input indicating a desired change in level of output power of the power controller; and
generating an audible signal corresponding to said desired change in output power of the power controller in response to a user input and to the particular output power level.

18. A method according to claim 17, wherein the user input is a touch of a touch-plate, and said change in output power is limited to a single discrete step with each touch of the touch-plate.

19. A method according to claim 17, wherein said generating step includes causing a piezoelectric device to provide the audible signal.

20. A method according to claim 17, further comprising the step of generating a visual signal corresponding to said change in output power of the power controller.

21. A method according to claim 17, further comprising the step of limiting said change in output power of the power controller to a single discrete step in accordance with a discrete user input.

22. A method according to claim 21, wherein said limiting step includes the step of latching a signal to the power controller using a latching circuit, thereby ensuring that only one discrete change in the output power occurs with each user input.

23. A method according to claim 17, wherein the power controller controls a device switched between ON and OFF states, and further comprising the steps of:
holding a most recent desired output power in accordance with switching the device to the OFF state; and
setting the output power to said most recent desired output power in accordance with subsequently switching the device to the ON state.

24. A method according to claim 17, further comprising the step of generating a visual signal corresponding to the change in output power of the power controller in response to the user input.
